(19) United States
(12) Patent Application Publication
(10) Pub. No.: US 2004/0254790 A1
(43) Pub. Date: Dec. 16, 2004

(54) Method, system and recording medium for automatic speech recognition using a confidence measure driven scalable two-pass recognition strategy for large list grammars

(75) Inventors: Miroslav Novak, Mohegan Lake, NY (US); Diego Ruiz, Galmaarden (BE)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY

(21) Appl. No.: 10/460,311

(22) Filed: Jun. 13, 2003

(51) Int. Cl. G10L 15/12; G10L 15/08

(52) U.S. Cl. 704/240

(57) ABSTRACT

A method, a system and recording medium in which automatic speech recognition may use large list grammars and a confidence measure driven scalable two-pass recognition strategy.

### BACKGROUND OF THE INVENTION

### Field of the Invention

An exemplary embodiment of the invention generally relates to the recognition performance of an automatic speech recognition system on large list grammars. More particularly, an exemplary embodiment of the invention relates to a method and system for automatic speech recognition (ASR) using a confidence measure driven scaleable two-pass recognition strategy for large list grammars in telephony applications.

### SUMMARY OF THE INVENTION

A user of a telephone application may make a selection from a large list of choices (e.g. stock quotes, yellow pages, etc.) using an utterance which may then be analyzed with respect to a large list grammar. Although the redundancy of the complete utterance is often high enough to achieve high recognition accuracy, a large search space may present a challenge for the recognizer, particularly when real time, low latency performance is required.

Automatic speech recognition (ASR) systems for telephony applications commonly use finite state transducers (FST), also called grammars, as language models. For many applications, such as digit strings, stock names and name recognition, the grammars may be relatively easy to design.

However, as the size of the task grows, the search may become more challenging. Although the overall word perplexity of the task may be low, the problem may be that the perplexity varies significantly during the search. In other words, the number of legal word choices may differ significantly from one grammar state to another. This may make a recognition system prone to search errors, especially if single pass real-time recognition is required. Pruning strategies developed for general large vocabulary recognition, in general, do not provide optimal results.

The present specification describes a few of the implications for a search in the context of an asynchronous decoder. One particularly useful system is the IBM speech recognition system which may use an envelope search that was derived from A* tree search. For this exemplary search to be admissible, the system may be able to find, given a particular incomplete path, an upper bound on the likelihood of the remaining part of this path because if the upper bound is overestimated, the search may be non-optimal.

In general, for large vocabulary ASR it may be assumed that the context of any partial path has only a short range effect (basically given by the N-gram span), so the cost of finishing a particular path until the end of the utterance may be similar (within some difference δ) to the cost of any other partial path ending around the same time. This assumption may allow the use of the likelihood of the best path at that time as the A* estimate. Thus, the δ may be used to trade between admissibility and optimality of the search.

However, this assumption may be inappropriate when a grammar is used. For example, a search of a partial path with a high likelihood in the middle of an utterance may not find any legal ending at all. Thus, a reliable estimate of the cost of the remaining path is difficult to find without investigating the acoustic features all the way until the end of the utterance.

For this reason, the search may be much wider at the beginning of an utterance, where perplexity is usually the highest. It may also be useful to know about the rest of the utterance when a pruning decision is made.

TABLE 1
Entropy of the first word in the utterance

| | Stock name | Name dialer | e-mail |
|---|---|---|---|
| Vocabulary size | 8040 | 30000 | 103 |
| H(Wf) | 11.24 | 12.9 | 4.24 |
| Perp(Wf) | 2508 | 7623 | 19 |
| H(Wf\Wt) | 5.03 | 2.16 | 3.02 |
| I(Wf;Wt) | 6.27 | 10.74 | 1.22 |

Table 1 shows the entropy H(Wƒ) of the first word in an utterance for three exemplary tasks each having a different vocabulary size. The first two tasks fall into the category of large lists. For comparison, a simple e-mail client application task having a smaller list is also shown. This third task may be described as a command and control type of task.

Table 1 clearly illustrates that the entropy H(W) of the first word Wf conditioned on the last word Wt of the utterance (i.e., H(Wƒ/Wt)) may be significantly lower than the unconditioned entropy H(Wƒ) for the large list tasks. Therefore, there may be high mutual information between the first and last word of the utterance, which suggests that knowledge about the end of the utterance might be very beneficial for search efficiency.

However, if we want to utilize such knowledge in a single-pass synchronous search, which provides the results with practically zero latency, this may be the least suitable choice because the synchronous search decision may not be changed once more information about the future becomes available.

Use of multiple-pass search strategies may seem like a better choice. For example, a cheaper and wide-open forward pass followed by a tight and precise backward pass might seem like a good choice, but this strategy may introduce an inherent latency into the system. The cheaper the first pass, the more expensive the second pass may be and the higher the latency.

Another potential problem with a multiple-pass strategy may be that the memory requirements for storing the results of the first pass may be significant.

In view of the foregoing and other problems, drawbacks, and disadvantages of the conventional methods and structures, an exemplary feature of the present invention is to provide a method and system in which automatic speech recognition using large list grammars may be performed using a confidence-measure-driven, scalable two-pass recognition strategy.

In a first exemplary aspect of the present invention, a method of automatic speech recognition may include performing a first search of a grammar to identify a word hypothesis for an utterance, applying a confidence measure to the word hypothesis to determine whether a second search should be conducted, and performing a second search of the grammar if the confidence measure indicates that a second search would be beneficial.

In a second exemplary aspect of the present invention, an automatic speech recognition system may perform a first search of a grammar to identify a word hypothesis for an utterance, apply a confidence measure to the word hypothesis to determine whether a second search is to be conducted, and perform a second search of the grammar if the confidence measure indicates that a second search would be beneficial.

In a third exemplary aspect of the present invention, a recording medium may store a compiler program for making a computer recognize a spoken utterance. The compiler program may include instructions for performing a first search of a grammar to identify a word hypothesis for an utterance, instructions for applying a confidence measure to the utterance to determine whether a second search is to be conducted, and instructions for performing a second search of the grammar if the confidence measure indicates that a second search would be beneficial.

In a fourth exemplary aspect of the present invention, a method of pattern recognition may include, performing a first search of a rule set to identify a sequence of features for a received signal, applying a confidence measure to the sequence of features to determine whether it would be beneficial to conduct a second search, and performing a second search of the rule set if the confidence measure indicates that a second search would be beneficial.

An exemplary embodiment of the present invention may provide a confidence-measure-driven, two-pass search strategy, which may exploit the high mutual information between grammar states to improve pruning efficiency while minimizing the need for memory.

On a conventional automatic speech recognition (ASR) telephony platform, one processor might handle several recognition channels. However, the recognition speed in these systems may have an adverse impact on the hardware cost. An exemplary embodiment of the invention may reduce the average recognition CPU cost per utterance for the price of a small amount of tolerable latency.

### BRIEF DESCRIPTION OF THE DRAWINGS

The foregoing and other purposes, aspects and advantages will be better understood from the following detailed description of exemplary embodiments of the invention with reference to the drawings, in which:

FIG. 1 illustrates an automatic speech recognition system 100 in accordance with an exemplary embodiment of the present invention; and

FIG. 2 illustrates a signal bearing medium 200 (e.g., storage medium) for storing steps of a program of a method according to an exemplary embodiment of the present invention;

FIG. 3 is a graph comparing the speed to error rate of an exemplary embodiment of the present invention on a stock name task;

FIG. 4 is a graph comparing the speed to error rate of an exemplary embodiment of the present invention on a name dialer task;

FIG. 5 is a flowchart of a search routine in accordance with an exemplary embodiment of the present invention; and

FIG. 6 is a block diagram illustrating one exemplary embodiment of the present invention.

### DETAILED DESCRIPTION OF EXEMPLARY EMBODIMENTS OF THE INVENTION

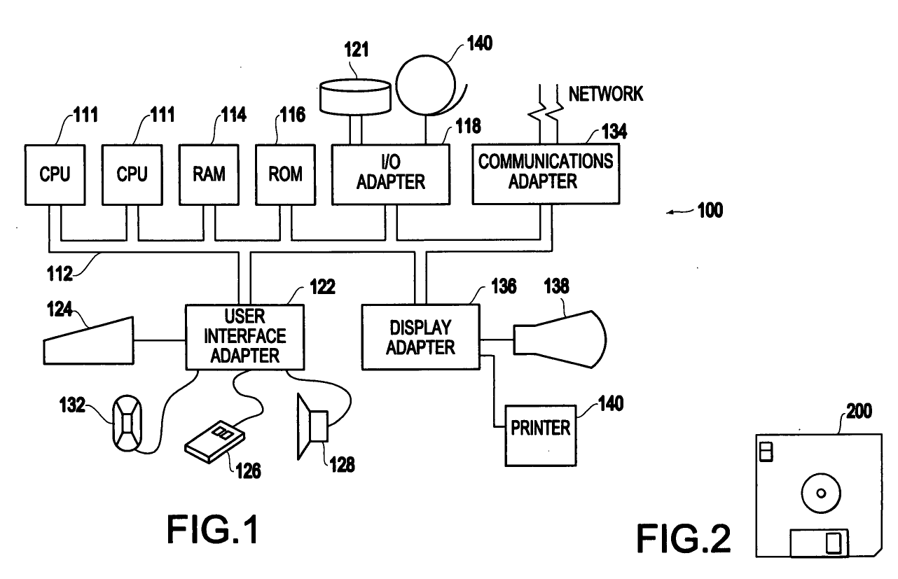

Referring now to the drawings, and more particularly to FIGS. 1-6, there are shown exemplary embodiments of the method and structures according to the present invention.

FIG. 1 illustrates a typical hardware configuration of an automatic speech recognition system 100 for use with the invention and which preferably has at least one processor or central processing unit (CPU) 111.

The CPUs 111 are interconnected via a system bus 112 to a random access memory (RAM) 114, read-only memory (ROM) 116, input/output (I/O) adapter 118 (for connecting peripheral devices such as disk units 121 and tape drives 140 to the bus 112), user interface adapter 122 (for connecting a keyboard 124, mouse 126, speaker 128, microphone 132, and/or other user interface device to the bus 112), a communication adapter 134 for connecting an information handling system to a data processing network, the Internet, an Intranet, a personal area network (PAN), etc., and a display adapter 136 for connecting the bus 112 to a display device 138 and/or printer.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 111, as represented by the fast-access storage for example. Alternatively, the instructions may be contained in another signal-bearing media, such as a magnetic data storage diskette 200 (FIG. 2), directly or indirectly accessible by the CPU 111.

Whether contained in the diskette 200, the computer/CPU 111, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

Further, in an exemplary embodiment which is not illustrated, the present invention may be implemented on a server which may form a portion of a telephony application. For example, the present invention may be useful in a customer service application within a telephony system to assist in speech recognition for the purpose of routing calls.

A first exemplary embodiment of the present invention is a variation of a two-pass search strategy which uses the most accurate model during the first pass. To minimize the latency caused by the second pass (and memory requirements as well), the first exemplary embodiment of the present invention performs as much of the search work as possible in the first pass which minimizes the cost associated with the second pass. The second pass is performed preferably only if there is an indication that a search error may have occurred in the first pass.

The first exemplary embodiment of the present invention includes the following steps:

1) Perform a standard single pass search with a sub-optimal search setting and store the intermediate search results;

2) Apply a confidence measure to the recognized utterance (identified hypothesis) and determine whether a search error is likely to have occurred in the first pass;

3) Compute information needed to speed up the second pass; and

4) Perform the second pass.

The sub-optimal first pass search preferably uses aggressive pruning techniques. As a result of these aggressive pruning techniques, the likelihood that the correct utterance may not have been selected as the hypothesis is increased. The confidence measure determines whether it is likely that the correct utterance may not have been selected and, if so, the second pass is performed to correct the error.

While the present invention is not limited by the type of search technique, it is preferred that a search technique which allows the results of the first pass to be stored efficiently and to produce new search hypothesis in the second pass is used to provide efficiency.

In the first exemplary embodiment of the present invention a commercially available IBM recognizer uses a multi-stack (one stack for each time) envelope tree search. The main processes performed by the decoder are: a fast match process, a detailed match process and a language model (grammar).

Preferably, the searches are iterative and start after an initial silence match at the beginning of an utterance, and select an incomplete path for extension with each iteration. The fast match process is performed first to obtain a list of possible words for extension along with corresponding scores. The fast match scores are then combined with the language model scores to create a shorter list of candidates for the detailed match. The detailed match is then performed to evaluate the candidates and to create and insert new nodes of the search tree into the corresponding stacks.

The detailed match process selects the time stack for a new path based on the “most likely boundary” time of the new hypothesis. It is important to note that this time is a discrete value, but an actual stack entry may represent the whole interval of possible word endings with corresponding likelihoods.

There are several parameters which may affect the search speed. Examples of these parameters include:

1) Envelope distance δ, which is the equivalent of the beam width in a Viterbi beam search. The envelope distance δ may be used to determine if a path should be extended or discarded. The envelope may be constructed from the best state likelihoods observed at each time.

2) Detailed match list size—may limit the number of word extensions which are evaluated for each path.

Since this first exemplary embodiment of the present invention assigns a unique boundary time to each incomplete path, the time-stack may be relatively sparse. The acoustic fast match process may use context independent models that can be shared across all paths ending at the same time. The fast match process may be performed when the stacks are not empty. Typically, the fast match is more expensive at the beginning of an utterance because that is where the perplexity is the highest. As the tree search progresses, the number of words the fast match needs to evaluate in subsequent calls may be quickly reduced due to the grammar constraints. Saving the results of the first fast match call for later use in the second pass is inexpensive because it is only one score per word, in contrast to common multi-pass techniques which need to store one score per word several times.

In a further exemplary embodiment of the present invention, if the fast match produces a list of hypothesis candidates which is greater than some threshold, then the list may be pruned by only selecting the top candidates for processing by the detailed match. This is an effective way of pruning, since the fast match may look ahead as much as one second.

Once the list is passed to the detailed match, time synchronous pruning may be used locally.

The standard method of performing automatic speech recognition ends when no path for extension can be found and the path with the best likelihood is selected.

In contrast, an exemplary embodiment of the present invention applies a confidence measure to determine if there is no better solution that may have been pruned away by the search. In other words, an exemplary embodiment of the present invention applies a confidence measure to determine whether it would be beneficial to conduct a second search.

The present invention is not limited by the type of confidence measure. Indeed, many confidence techniques which may be used in conjunction with the present invention may be found in the literature. For example, approaches based on word a posteriori probabilities which were computed from word graphs are popular. However, this technique may not be useful when used with a word lattice that is not sufficiently dense in the presence of search errors.

Preferably, an inexpensive technique which can be tuned to provide a very low false acceptance rate may be used in an exemplary embodiment of the invention. False rejections are much less costly in terms of error rate because false rejections are the only errors which cause unnecessary computations in the second pass.

An exemplary embodiment of the invention uses the confidence measure to assess the possibility of a search error. Although, the invention is not limited to any particular heuristic features, the inventors have determined that the following examples of heuristic features may work in conjunction with the exemplary embodiments of the invention:

1) Average frame likelihood of the decoded path, including normalization components of the likelihood computation. This normalization forces the likelihood of the correct path to be a roughly a linear function of time. A search error typically causes a much lower likelihood for the path.

2) Relative fast match score of the first word

It should be Pfm(W′), not Pfm(W′)′

$$S ( W ) = \frac{{P}_{fm} ( W )}{{\sum }_{{w}^{′} ∈ v} {P}_{fm} ( {W}^{′} )} \qquad ( 1 )$$

where:

Pƒm(W) is the likelihood (not log likelihood) of the word based on the fast match.

The first fast match call may provide a list of all possible first words, so that any complete path will contain one word from this list in the first position. This relative score can be viewed as an approximation of the first word a posteriori probability. The higher the score, the lower the chance that some other word will assume the first position in the path. The present inventors discovered that this score appears to be a good predictor of search errors.

The decoded path (i.e. the hypothesis) may be labeled as search error free (i.e., accepted) if either one of these measures is above some predetermined threshold. If the decoded path (i.e. the hypothesis) is rejected, an exemplary embodiment of the present invention then may perform the second pass. Preferably, any computation performed in the second pass is not expensive so that the latency is not increased.

In an exemplary embodiment of the invention, the fast match for the second pass may be performed once in the reverse direction from the end of the utterance to obtain a list of candidates for the last word.

The fast match candidates from the utterance beginning computed during the first pass and the fast match candidates from the end of the utterance may now be combined. Only some of these combinations may be legal (as defined by the grammar), and the pairs may then be sorted in accordance with their combined log likelihood's as shown in Equation (2).

S(W_{ƒ}, Wₗ)=log P_{(forward)}(W_{ƒ})+log P_{(backward)}(Wₗ) (2)

The ranking of the candidates for the first word based upon these combinations may now be significantly different from the previous ranking which was only based on the forward match. Therefore, an exemplary embodiment of the present invention may revisit the list of detailed match candidates from the first pass. It may then be determined if each candidate was already processed during the first pass starting with the top candidate in this new list. If the exemplary embodiment determines that a candidate was not processed during the first pass, the candidate is added to a new list. This process may be stopped after the number of added words reaches a certain limit. The rest of the search may be basically the same as in the first pass, but new paths can be pruned more efficiently due to the search envelope built during the first pass.

The present inventors conducted experiments using an exemplary embodiment of the present invention on a telephony system. Cepstral coefficients were generated at a 15 ms frame rate with overlapping 25 ms frames. Nine frames were spliced together, linearly-transformed and projected using linear discriminant analysis and maximum likelihood linear transformation into a 39 dimensional feature vector. A cross-word left-context pentaphone acoustic hidden markov model model (HMM) was built with 1080 states and 160000 Gaussians.

The computation of HMM state probabilities was limited to the top 256 best states at each time frame. The probabilities were stored in memory for the whole utterance, so that they were available during the second pass. Rather than using Gaussian mixture probabilities directly, the present inventors converted them to probabilities based on their rank when sorted by GMM probability.

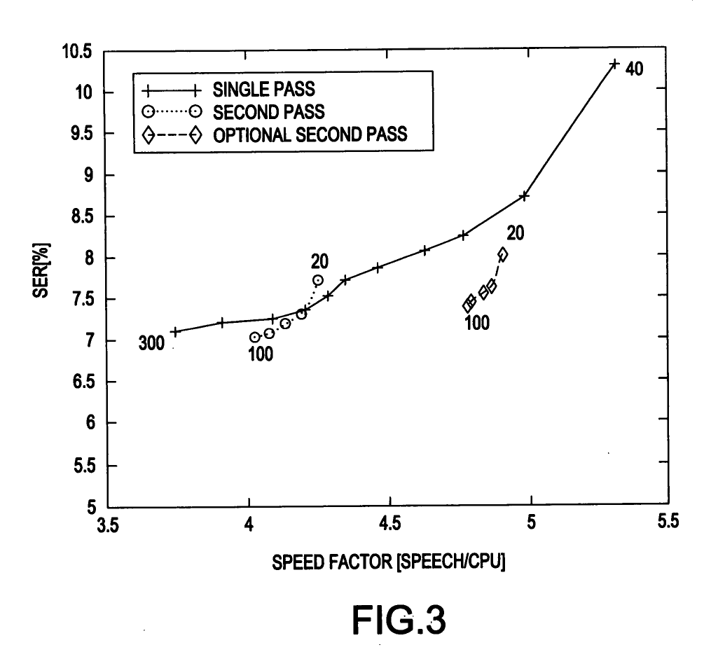

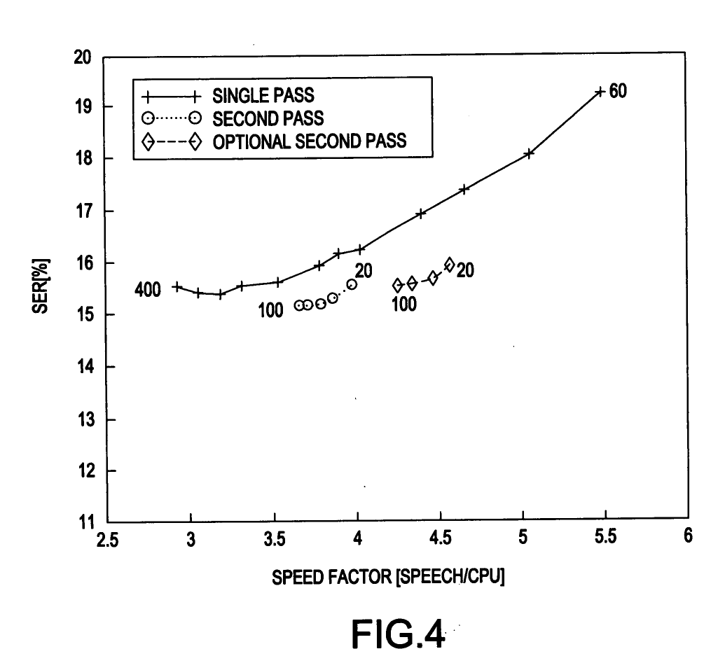

The results for these experiments are shown in FIG. 3 for the stock name task and in FIG. 4 for the name dialer task. The grammar contained 25 thousand choices for the stock names and 86 thousand choices for the name dialer. In both cases, the average utterance length was 2.9 words.

The speed is represented by a ratio of the total duration of utterances and the total CPU time that was consumed by the decoder. The present inventors prefer this form because it is directly correlated to the number of decoders which may run concurrently on one CPU.

The inventors considered the first task (stock name) as a development set, to explore a wide variety of parameter settings and chose the optimal settings. In particular, the confidence measure threshold was selected for this task. The second test set was then used to verify the robustness of the selected parameters.

The solid curve shows the sentence recognition error rate of the baseline (e.g. conventional single pass) system when the value of the detailed match list was varied from 40 to 400. The dotted line shows the performance of the inventive two-pass system when the second pass was always performed. To achieve a visible speed improvement, the inventors chose a relatively small detailed match list size for the first pass. Otherwise, the second pass only slowed the system without contributing to any accuracy improvement.

For the second pass, the inventors varied the list size from 20 to 100. It can be seen that the overhead of the second pass can eliminate the speed improvement. The most significant part of this overhead appears to be the computation of the reversed fast match. Only when the inventors used the confidence measure to avoid the second pass, was a noticeable improvement achieved (dashed line).

Similar behavior was observed for the name dialer task as shown in FIG. 4. However, the error rate was slightly higher due to imperfections in the confidence measure.

On the name dialer task, the second pass search was performed on 56% of all utterances in the test set. The actual search time attributed to the second pass represents 28% of the total decoding time. The average latency was 0.12 seconds per utterance, across all utterances. When the inventors considered only those utterances for which the second pass was computed, the average latency was 0.2 seconds.

The two-pass search algorithm of an exemplary embodiment of the present invention improves the speech recognition performance in telephony applications by trading a tolerable latency for a reduced average CPU cost per utterance.

The present invention may be used whenever a grammar state with high mutual information between its outgoing arcs and incoming arcs of the final state exists. Indeed, the present invention may be used between any two states of a grammar.

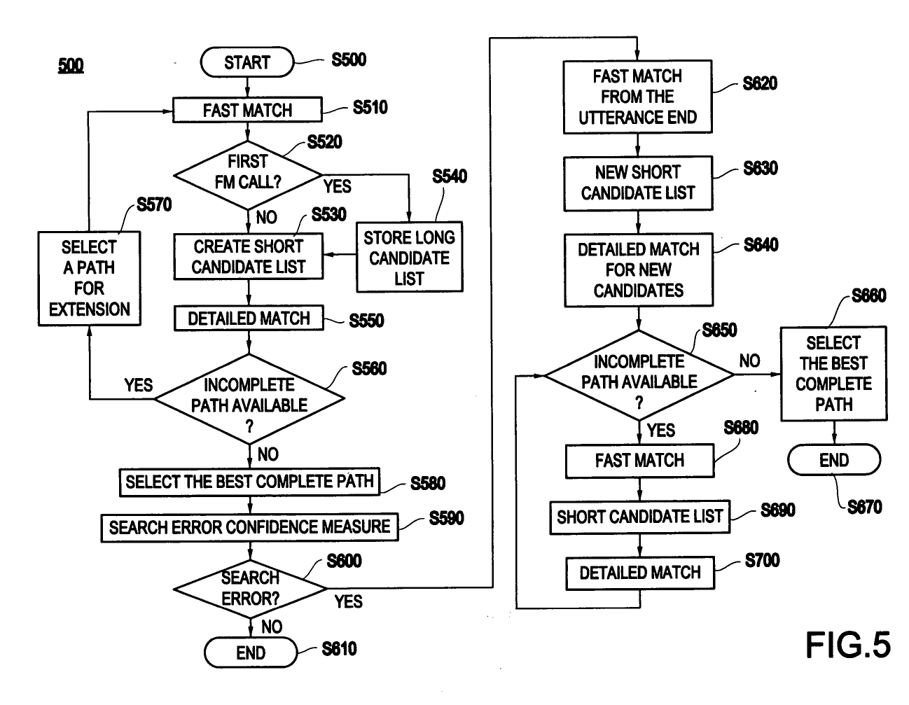

FIG. 5 illustrates a flow chart of one exemplary search method in accordance with the present invention. The search routine starts at step S500 where the search is initialized by an empty path (containing no words) at the beginning of an utterance, after the initial silence is matched. This path is then selected for extension.

The search routine then continues to step S510 where a fast match process provides a list of word candidates which can extend the selected path. Each candidate receives a likelihood based score P(w). This list is called a “long candidate list,” because it contains more words than will be eventually used.

The search routine then continues to step S520, where the routine determines whether the current fast match call is the first call in the utterance. If, in step S520, the search routine determines that the current fast match call is the first call in the utterance, then the search routine continues to step S540. In step S540, the search routine stores the long candidate list for later use in the second search pass.

If, on the other hand, in step S520, the search routine determines that the current fast match call is not the first call in the utterance, the search routine continues to step S530. In step S530, the search routine reduces the long list by sorting the word candidates based upon their combined fast match and language model scores and selecting the top N candidates (e.g., a “short candidate list”).

The control routine then continues to step S550 where the control routines process the short list in a detailed match. Those words which are successfully matched in the detailed match then extend the current search path. These new paths are inserted on the search stack.

The search routine then continues to step S560. In step S560, the search routine determines whether all of the paths on the stack are complete (i.e. at the utterance end).

If, in step S560, the search routine determines that all of the paths on the stack are not complete, then the search routine continues to step S570. In step S570, the search routine selects an incomplete path for extension and the search routine returns to step S510. Therefore, the search cycle is repeated iteratively until all paths are either completed or pruned out by the search.

If, on the other hand, in step S560, the search routine determines that all of the paths on the stack are complete, then the search routine continues to step S580. In step S580, the search routine selects the best complete path on the stack as the recognized path (i.e., the identified hypothesis).

The search routine then continues to step S590. In step S590, the search routine applies a confidence measure to the recognized path (i.e., the identified hypothesis). The search routine then continues to step S600 where the search routine determines whether a search error is likely to have occurred based upon the results of the confidence measure.

If, in step S600, the search routine determines that a search error is not likely to have occurred then the search routine continues to step S610 where the search routine is stopped.

If, on the other hand, in step S600, the search routine determines that a search error is likely to have occurred, then the search routine continues to step S620. In step S620, the search routine performs a fast match in the reverse time direction starting at the end of the utterance to generate a list of word candidates which may occur as the last word of the utterance.

The search routine then continues to step S630. In step S630, the search routine creates a list of possible combinations of first words (stored in step S540) and last words (produced in the previous step S620) using a language model. This list is also sorted by the combined scores of both words in the pair in step S630.

The search routine then continues to step S640. In step S640, the search routine creates a new list of word candidates to start the utterance by taking only the first elements of the sorted word pairs of the sorted list from step S630. The search routine also compares this list with the list of words generated by the detailed match at the beginning of the utterance in the first pass and inserts the words which were not processed by the detailed match during the first pass on the stack.

The search routine then continues to step S650. The remaining steps S650-S690 are identical to steps S510-S560 in the sense that iteration over steps S680-S700 are repeated as long as incomplete paths exist on the stack.

The search routine ends at step S660 and S670 where the search routine selects the best complete path on the stack as the hypothesis.

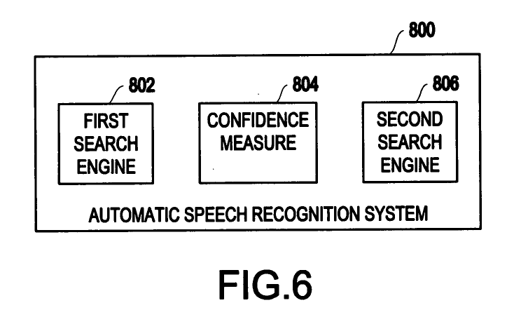

FIG. 6 illustrates an automatic speech recognition system 800 in accordance with one exemplary embodiment of the present invention. The automatic speech recognition system 800 may include a first search engine 802, a confidence measure 804 and a second search engine 806. The first search engine 802 may perform a first search of a grammar to identify a word hypothesis for an utterance. The confidence measure 804 may be applied to the word hypothesis to determine whether a second search is to be conducted. The second search engine 806 may perform a second search of the grammar if the confidence measure 804 indicates that a second search would be beneficial. The components of the automatic speech recognition system 800 may be formed of anything that is capable of providing the above-described features of an exemplary embodiment of the invention.

While the above detailed description focuses upon a type of system and method where the grammar simply enumerates all possible choices. The invention provides particular advantages where the number of choices is large (thousands or more).

Further, while the above detailed description focuses upon automatic speech recognition, the present invention may be useful in any pattern recognition system which may rely upon a rule set to define potential relationships between features and to identify a particular sequence of features within a signal stream.

In the automatic speech recognition system described above, an utterance may correspond to a signal stream, a feature may correspond to a word, a sequence of features may correspond to a sequence of words and the grammar may correspond to the rule set which defines potential relationships between words. The detailed description does not limit the scope of the invention to automatic speech recognition and is intended to encompass pattern recognition.

While the invention has been described in terms of several exemplary embodiments, those skilled in the art will recognize that the invention can be practiced with modification.

Further, it is noted that, Applicant's intent is to encompass equivalents of all claim elements, even if amended later during prosecution.

What is claimed is:

1. A method of automatic speech recognition, comprising:
performing a first search of a grammar to identify a word hypothesis for an utterance;
applying a confidence measure to the word hypothesis to determine whether a second search is to be conducted; and
performing a second search of the grammar if the confidence measure indicates that a second search would be beneficial.

2. The method of claim 1, wherein said confidence measure determines whether a word hypothesis having a higher probability of matching said utterance was not identified.

3. The method of claim 1, further comprising computing information for increasing a speed of the second search.

4. The method of claim 1, wherein said first search comprises a sub-optimal search.

5. The method of claim 1, wherein the first search comprises an aggressive pruning technique.

6. The method of claim 1, wherein said first search comprises a fast search and a detailed search, and wherein said aggressive pruning technique comprises:
determining a number of candidates for said hypothesis generated during said fast search; and
selecting the top candidates for processing by said detailed search if the number of candidates exceeds a threshold.

7. The method of claim 6, wherein said confidence measure evaluates if a better hypothesis may have been pruned.

8. The method of claim 1, wherein said confidence measure evaluates a likelihood that a correct match was missed.

9. The method of claim 1, wherein performing one of said first search and said second search comprises performing a fast match process and a detailed match process.

10. The method of claim 1, wherein performing one of said first search and said second search comprises performing an iterative search.

11. The method of claim 1, wherein performing one of said first search and said second search comprises:
performing a fast match to obtain a list of possible words for extension in a search tree along with corresponding scores;
combining said list of possible words with language model scores to shorten the list of possible words; and
performing a detailed match to evaluate the shortened list of possible words and to create and insert new nodes along the search tree by selecting a time stack for a new path based upon a most likely boundary time of each new node.

12. The method of claim 11, wherein said word hypothesis comprises the path in said search tree having the best likelihood of being correct.

13. The method of claim 1, wherein said confidence measure comprises an approach based on word a posteriori probabilities from at least one word graph.

14. The method of claim 1, wherein said confidence measure assesses a possibility of a search error.

15. The method of claim 14, wherein said confidence measure assesses a possibility that a better word hypothesis may have been missed.

16. The method of claim 14, wherein said confidence measure assesses the possibility of a search error by determining an average frame likelihood of the word hypothesis.

17. The method of claim 16, wherein said confidence measure determines a normalized average frame likelihood of the hypothesis.

18. The method of claim 17, wherein said confidence measure determines a search error when said normalized average frame likelihood of the word hypothesis is lower than a predetermined threshold.

19. The method of claim 1, wherein said first search comprises a search in a forward direction, and wherein said second search comprises a search in a reverse direction.

20. The method of claim 19, wherein said second search comprises a fast match search in the reverse direction from an end of the utterance to obtain a list of candidates for a last word.

21. The method of claim 19, wherein the first search generates a first list of word candidates based on said forward search direction, and wherein said second search generates a second list of word candidates based on said reverse search direction, and wherein said second search comprises:
combining said first list of word candidates with said second list of word candidates;
determining combinations of said word candidates which are legal in accordance with said grammar; and
sorting said legal combinations according to their combined likelihoods;
determining whether one of said sorted legal combinations was processed during said first search;
adding said one of said sorted legal combinations to a new list if it is determined that said one of said sorted legal combinations was not processed during said first search; and
selecting said hypothesis from said new list and from the candidates which were processed during said first search.

22. An automatic speech recognition system comprising:
means for performing a first search of a grammar to identify a word hypothesis for an utterance;
means for applying a confidence measure to the word hypothesis to determine whether a second search is to be conducted; and
means for performing a second search of the grammar if the confidence measure indicates that a second search would be beneficial.

23. A recording medium storing a program for making a computer recognize a spoken utterance, said program comprising:
instructions for performing a first search of a grammar to identify a hypothesis for an utterance;
instructions for applying a confidence measure to the utterance to determine whether a second search is to be conducted; and
instructions for performing a second search of the grammar if the confidence measure indicates that a second search would be beneficial.

24. A method of pattern recognition, comprising:
performing a first search of a rule set to identify a sequence of features for a received signal;
applying a confidence measure to the sequence of features to determine whether it would be beneficial to conduct a second search; and
performing a second search of the rule set if the confidence measure indicates that a second search would be beneficial.
